(19) United States
(12) Patent Application Publication
(10) Pub. No.: US 2015/0046270 A1
(43) Pub. Date: Feb. 12, 2015

(54) System and Method of Using Artificial Intelligence to Valuate Advertisements Embedded Within Images

(71) Applicant: Saper Kocabiyik, Plainview, NJ (US)

(72) Inventor: Saper Kocabiyik, Plainview, NJ (US)

(21) Appl. No.: 14/054,989

(22) Filed: Oct. 16, 2013

Related U.S. Application Data
(60) Provisional application No. 61/863,048, filed on Aug. 7, 2013.

(51) Int. Cl. G06Q 30/02

(52) U.S. Cl. CPC G06Q 30/0273; G06Q 30/0275
USPC 705/14.71; 705/14.69

(57) ABSTRACT

In an embodiment of the disclosed technology, advertisements are embedded on specific regions within already displayed images on websites, and valuated based on characteristics of the region with respect to the image as a whole and the corresponding web page. A method involves detecting a particular region of an image which primarily contains a particular item or type of content. The detected region of the image is analyzed pursuant to a number of factors. The factors are generally indicative of the value of the region in the context of the image as a whole, and the value of the image in the context of the page as a whole. The factors may include determining the prominence, position, relevance and size of the region within the image, as well as the image within the page. The particular regions of the image may then be assigned a value.

### FIELD OF THE DISCLOSED TECHNOLOGY

The disclosed technology relates generally to online advertising and, more specifically, to content-specific advertisements based on prominence and position in an image as determined by artificial intelligence.

### BACKGROUND OF THE DISCLOSED TECHNOLOGY

Web-based advertising has become an extremely large industry. Many websites display advertisements in order to generate income and traffic. The very foundation of many free web services is the generation of income based on cost-per-click and/or cost-per-impression ads. Such ads may be in the form of text, banner, and/or rich-media.

Rich-media and banner advertisements often incorporate images. However, the image typically contains a single hyper-link to the web page associated with the content of the advertisement. That is, when the image is clicked on, regardless of which portion or region is clicked, a user is transported to the associated webpage, and the advertiser pays a pre-determined price for the click. Up to now, image-based advertisements have not parsed an image into regions, sections, or individual items based on the content of the image. Thus, a single banner atop a web page may only generate a single stream of income, based on individual clicks or impressions based on the banner.

Artificial intelligence involves computer technology that is able to perceive, process and take action based on varying real-world factors. In the context of images, text and video, artificial intelligence is capable of recognizing, classifying and reacting to various objects, strings of texts, sounds, and other sub-media within a given medium. For example, artificial intelligence may be employed to detect objects within an image, and take specific actions based on that recognition.

Therefore, there is a need in the art to provide content-based image advertising which parses an image into two or more distinct regions or items, each of which is associated with a different advertiser and/or keyword.

### SUMMARY OF THE DISCLOSED TECHNOLOGY

Therefore, it is an object of the disclosed technology to embed advertisements on specific regions within already displayed images on websites, and to valuate the advertisements based on characteristics of the region with respect to the image as a whole and the corresponding webpage.

As such, in an embodiment of the disclosed technology, a method uses artificial intelligence for setting a value on a clickable portion of an image. The method is carried out, not necessarily in the following order, but may be in the order of: a) displaying a rendered visual representation of a webpage on a display device, the webpage having an image; b) defining at least one region within the image, the at least one region having a detected visual representation of an object; c) valuating, using a processor, the at least one region based on properties of the region relative to the image; d) valuating, using a processor, the entirety of the image based on characteristics of the image and placement of the image within the webpage; and e) charging an advertiser a price for an advertisement associated with the region based on the aforementioned steps of valuating.

The step of valuating each region may be based on at least two of the following: a) a position of said region in said image; b) a size of said region relative to said image; and c) a relevance of said region to said page. In embodiments, the relevance of the region to the page may be based on text displayed on the page. Further, the relevance of the region to the page may further be based on content displayed on the page.

In a further embodiment of the disclosed method, the step of valuating the image itself may be based on at least two of the following: a) a position of the image on the page; b) a relevance of the image to the page; and c) a quality of the image. The method may further comprise a step of setting a keyword associated with the region. The keyword may be representative of content of the region. Still further, the assigned price may be a starting bid price of an advertising content auction.

In another embodiment of the disclosed technology, a method uses artificial intelligence for setting an auction price of an advertisement associated with a region of an image. The method is carried out, not necessarily in the following order, by: a) setting a keyword associated with said region, said keyword representative and descriptive of content of the region; b) determining a characteristic of the region relative to other parts of the image; c) determining a quality of the image; d) determining a position and prominence of the image on a page; e) determining a position and prominence of the region within the image; and f) setting a starting bid price based on the steps of determining. Some or all of the aforementioned steps may be carried out by a processor.

Upon making the aforementioned determinations, a rating may be assigned to the region based thereon. The steps of determining position and prominence of the region within the image may be based on whether the region is determined to be in the background or the foreground of the image. In further embodiments, the image is displayed on a rendered visual representation of a webpage on a display device. A “display device,” for purposes of this specification, is defined as any electronic device having an LCD screen, a LED screen, a plasma screen, an electrophoretic ink screen. or any other electronic display capable of displaying visual representations of content.

In yet another embodiment of the disclosed technology, a non-transitory computer-readable storage medium has artificial intelligence instructions designed to be carried out by a processor. The instructions are carried out, not necessarily in the following order, by: a) displaying a rendered visual representation of an image; b) defining at least one region within the image, the region having a detected visual representation of an object; c) valuating the region based on properties of the region relative to the image; d) valuating the entirety of the image based on a position of the image; and e) charging an advertiser a price for an advertisement associated with said region based on said steps of valuating.

In embodiments, the visual representation of an image may be displayed on a medium, such as, for example, a web page. The web page may be accessible by any device having a display and connectivity to a network sufficient to access and display the image. In further embodiments, the instructions may have additional steps of: a) valuating a placement of the image within the web page; b) setting a keyword associated with said region, said keyword representative of content of said region; and/or c) valuating a relevance of the region to the web page. The relevance of the region to the page may be based on text displayed on the web page.

It should be understood that the use of “and/or” is defined inclusively such that the term “a and/or b” should be read to include the sets: “a and b,” “a or b,” “a,” “b.”

### BRIEF DESCRIPTION OF THE DRAWINGS

FIG. 1 is a flow chart outlining the steps of an overview of a method of carrying out an embodiment of the disclosed technology.

FIG. 2 is a flow chart outlining the steps of detecting and assessing content of a method of carrying out an embodiment of the disclosed technology.

FIG. 3 shows a screen shot of a browser window with in-image advertising, according to an embodiment of the disclosed technology.

FIG. 4 shows an exemplary flow diagram for valuating content based on a number of factors, according to an embodiment of the disclosed technology.

FIG. 5 shows an example of advertisement regions and valuations that may be embedded in the image of FIG. 3.

FIG. 6 shows a high-level diagrammatic overview of a network configuration for carrying out an embodiment of the disclosed technology.

FIG. 7 shows a high-level block diagram of a device that may be used to carry out the disclosed technology.

### DETAILED DESCRIPTION OF EMBODIMENTS OF THE DISCLOSED TECHNOLOGY

In an embodiment of the disclosed technology, a method is used for embedding and valuating advertisements on content within images. The method involves detecting a particular region of an image which primarily contains a particular item or type of content. The image may be on a web page or other interface having web connectivity, such as, for example, a mobile phone application or a smart television. The detected region of the image is analyzed pursuant to a number of factors. The factors are generally indicative of the value of the region in the context of the image as a whole, and the value of the image in the context of the page as a whole. The factors may include determining the prominence, position and size of the region within the image, as well as the image within the page. Another factor may assess the relevance of the region with respect to the image, and the relevance of the image with respect to the page. The particular regions of the image may then be assigned a value, the basis of which may be used for assigning a minimum bid price for advertising on or within that region.

Embodiments of the disclosed technology will become clearer in view of the following description of the drawings.

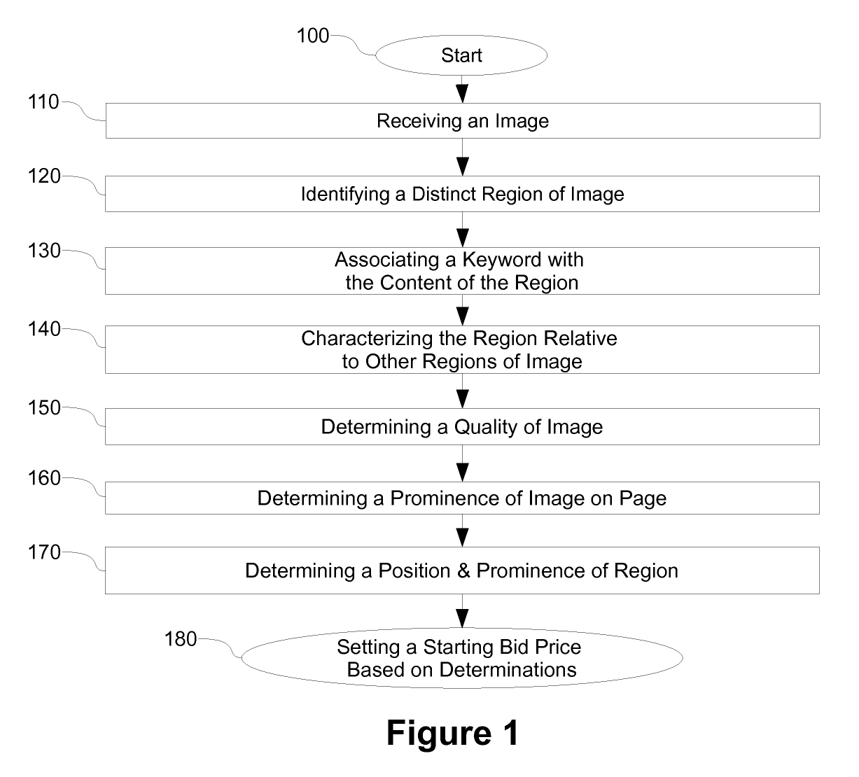

FIG. 1 is a flow chart outlining the steps of an overview of a method of carrying out an embodiment of the disclosed technology. The method begins in step 110 with receipt of an image at a server, node, or other location. The image may be any graphic that is in digital form. The image may be, for example, a JPEG, a BMP, a PNG or any other static type of digital image. Alternatively, the “image,” for purposes of this specification, may be a series of images, a movie file (such as a MOV, AVI, MPG), or a GIF file.

Next, the image is analyzed to identify one or more distinct regions in step 120. The analysis may be carried out using image-recognition instructions carried out in automated fashion or by way of a person using input devices (such as a mouse, keyboard, and/or touchscreen) to define areas of an image as distcint regions. When using automated image-recognition instructions (e.g. software), it is operable to detect and identify recognizable objects, texts, faces, etc. within the image. For example, the software may identify a commercial airplane in the portion of the picture. In step 130, the keyword “airplane” may be associated with the particular region within which a recognizable and distinct object was identified. Although not required, the keyword may be used by advertisers in searching for appropriate advertising space. Further, other closely associated words such as “flights,” “airports,” and “airlines” may also be associated with the region for purposes of searching and search results of web pages presented to users.

Next, the region is further analyzed based on a number of factors. Thus, in step 140 the region is characterized relative to other regions of the images. That is, it is determined whether the airplane is the focal point of the image or is a small speck in the sky in an image of something completely unrelated to “air travel.” Proceeding along these lines, in step 150, the quality of the image is determined. The higher the resolution of the image, the more valuable ad-space within the image will be. Next, in step 160, the prominence of the image with respect to the page is determined. Thus, if according to steps 150 and 160 the image is merely a 100 pixel×100 pixel square at the bottom corner of the page, advertisements associated therewith would be less valuable.

Proceeding to step 170, the position and prominence of the region within the image is determined. Steps 130 through 170 need not necessarily be carried out in the order shown. Moreover, determinations made during some steps may carry more importance or weight than those made during other steps. That is, the prominence of the region within the image may be, for example, weighted as the single most important factor determinative of value for that particular region.

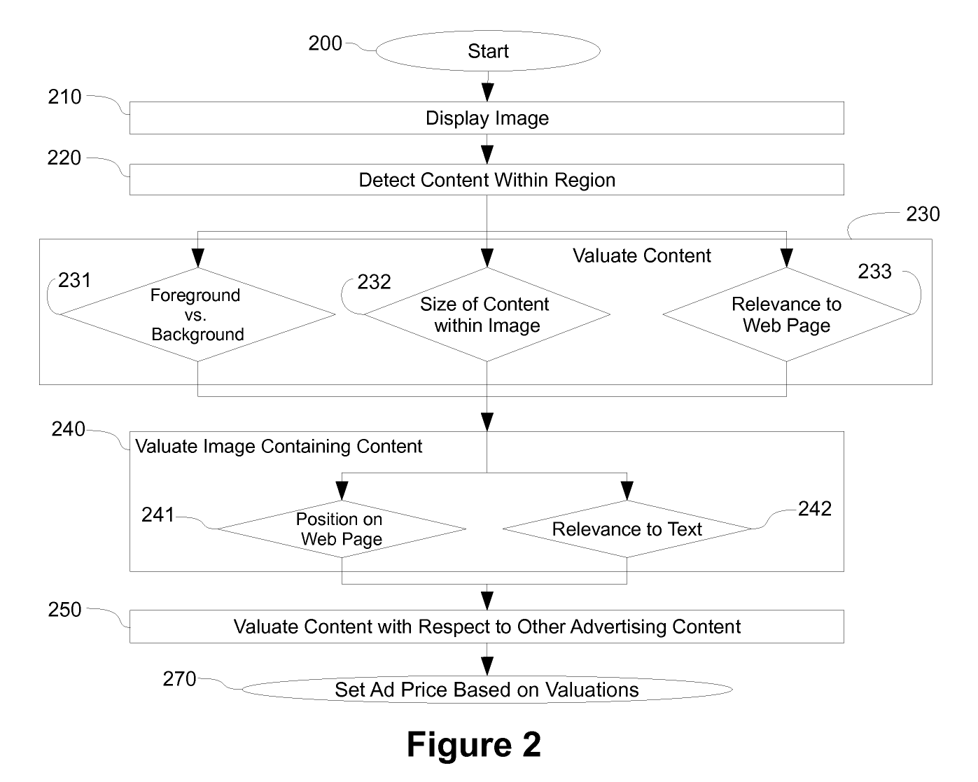

FIG. 2 is a flow chart outlining the steps of detecting and assessing content of a method of carrying out an embodiment of the disclosed technology. The method shown in FIG. 2 separates the valuation determinations into two distinct parts: 1) the value of region within the context of the image; and 2) the value of the image within the context of the web page. A third part valuates the advertisement content with respect to other advertising categories on the Internet. After initiation of the method (step 200), an image is displayed in step 210. Next, in step 220, content is detected within a region of the image.

Valuation of the content within the region is carried out in step 230. Step 230 involves several sub-steps which evaluate the content of the region within the context of the image. Step 231 involves making a determination as to whether the region is in the foreground or the background of the image. Step 232 is directed to determining the size of the content within the image. This determination may be, for example, determining what percentage of the total image is occupied by the region in which the detected content resides. Next, in step 233, the relevance of the content is determined with respect to the web page.

In step 240, the next series of valuations is carried out with respect to the image itself. For an image with multiple regions and/or detect content, step 240 needs to be carried out only once, in view of the fact that for each region within the image, the image itself, as well as the image's relationship with the page, remains constant.

A sub-step of step 240 is step 241, wherein the position of the image on the page or other visual interface is assessed. That is, a determination is made as to the prominence of the image on the particular page on which it is being displayed. For example, if the image is front and center at the top of the page as it loads, then the image will be rated highly on this factor. Alternatively, if the image is one of 150 similarly situated images on a single web page, then the image may be rated poorly in this category.

Another sub-step in evaluating the image is determining the relevance of the image to the text of the page. That is, does the content displayed in the image correlate to the page on which it appears. For example, a photo of an exotic tropical cottage would be considered highly relevant to a travel web page. Further, it would be even more relevant on a Caribbean vacation rental web page.

Yet another step in evaluating the content of the region as a whole involves evaluating the content with respect to other advertising content around the web (step 250). During this step, the particular keyword descriptive of the region may be compared against a large database of words or phrases. For example, the keyword “football” may be much more popular and prevalent than the keyword “cassette.” As such, the keyword and associated regions descriptive of, or associated with, “football” would have a higher advertising price and/or valuation.

At the end of this particular process, after all the factors are determined and assessed, the artificial intelligence assigns a final ad valuation is assigned in step 270. The valuation may be given based on a scale, such as, for example, a scale between 1-10, each incremental value having an associated minimum or starting bid price. Alternatively, a bid price may be stipulated based on the factors using an equation or algorithm which weights the different factors according to their importance.

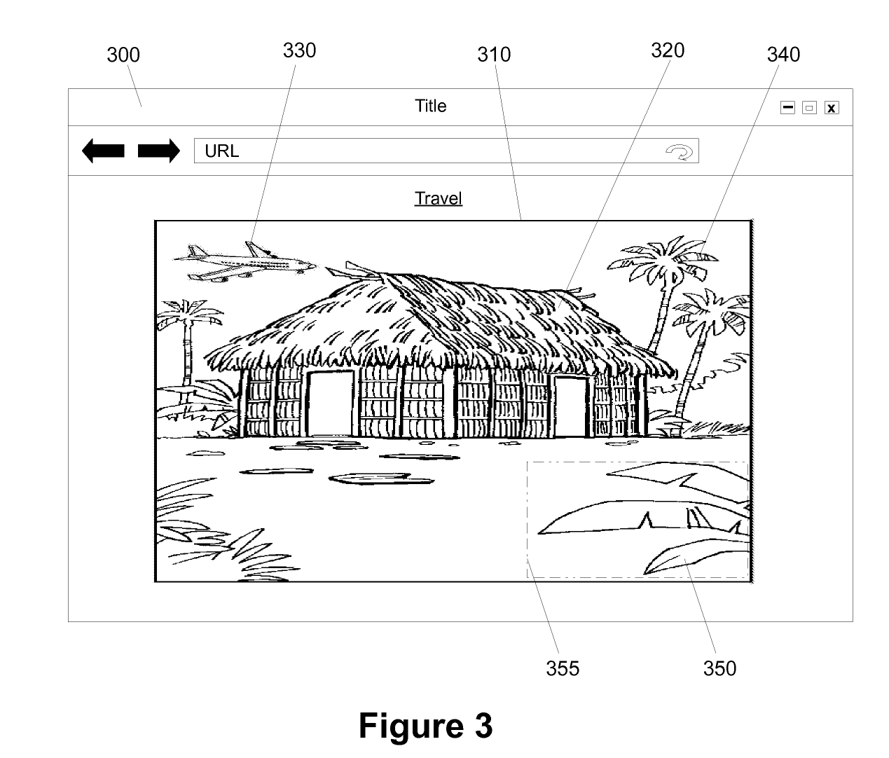

FIG. 3 shows a screen shot of a browser window with in-image advertising, according to an embodiment of the disclosed technology. The figure shows a browser window 300, typical of a web browser for an internet connected device. The exemplary image 300 is displayed on the web page content portion of the web browser.

As previously stated, the image need not be displayed on a web browser per se. The image may be displayed within a software interface, a mobile application, or any other visualization capable a being displayed on an internet or LAN connected device. Moreover, the image need not be static, insofar as it may be a movie, GIF, flash animation/video, slideshow, or other visual media capable of being displayed.

In the example image shown in FIG. 3, several regions containing content or features are present. The focal point of the image is a cottage 320, because it is the largest discernible object in the image, and is likely the first object recognized by an individual viewing the image. An airplane 330 and some palm trees 340 are also clearly recognizable in the image, although these objects appear in the background of the image. Similarly, a plant 350 is shown in the front of the image, although it is not the focal point of the image. Each of these objects may be assigned a region, as denoted by the dotted rectangular 355 surrounding the plant 350. This designated region may display an ad upon being clicked or upon a user placing a pointer over the region (such as by using a mouse). As such, a corresponding advertisement may be or is displayed, opened, or otherwise brought to the attention of the user.

Although only one is shown in FIG. 3 for explanatory purposes, multiple regions may exist around the image corresponding to the different recognizable objects. Moreover, the regions may overlap, and the region with the higher valuation may take precedent over one with a lower valuation. Thus, in the example shown, if the region containing the cottage 320 overlapped with that of the plant 355, the region correlating to the cottage would take precedent in the overlapped area due to the cottage's greater prominence within the image.

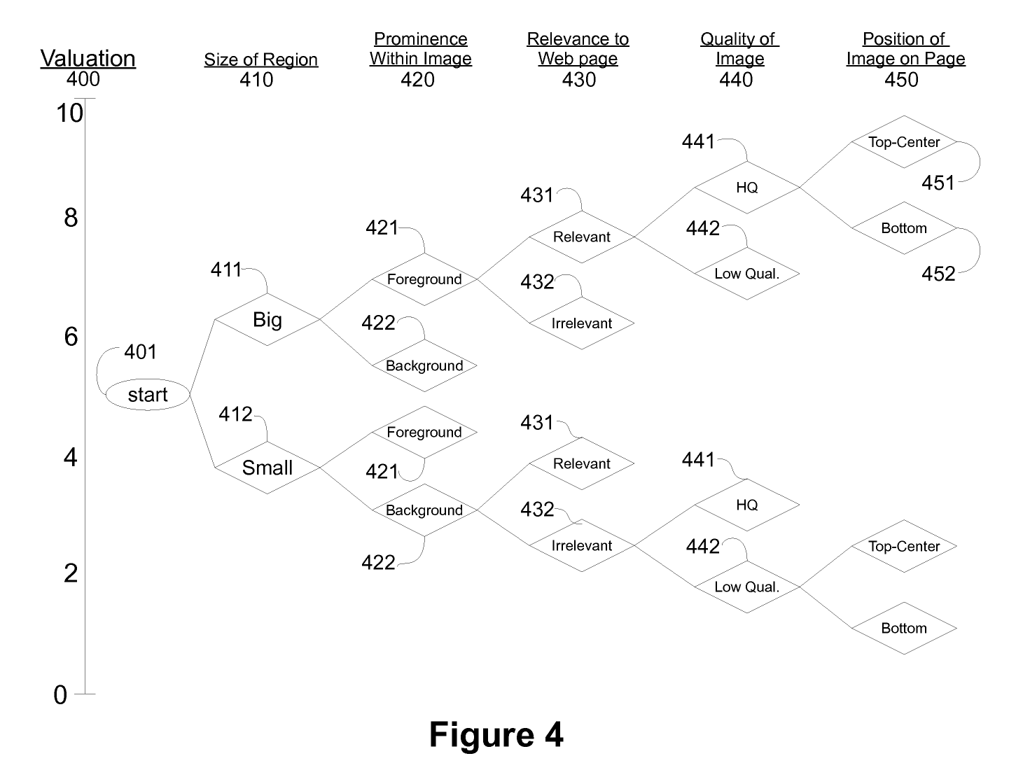

FIG. 4 shows an exemplary flow diagram for valuating content based on a number of factors, according to an embodiment of the disclosed technology. The content detected from an image, such as that shown in FIG. 3, may be graded or valued based on a number of factors. As discussed with respect to FIGS. 1 and 2, the multiple factors may be used in determining the valuation of an advertisement associated with a given region. The determination of the valuation may be assessed using a methodology similar to that found in the flow diagram of FIG. 4.

Referring specifically to the diagram, a valuation scale 400 from 1 to 10 is used as an example. The method for analyzing a particular advertising region starts at step 401, which in this example is roughly equivalent to a 5 on the valuation scale. The region or content may start at any valuation or price. The starting valuation, absent image-specific determinations, may be based on current market values for keywords and images directed to similar subject matter.

The first factor under the methodology of FIG. 4 is the size of the region 410 within the image. If the region is large, then the method proceeds to 411. If it is small, then the method proceeds to 412. There is no limit to the number of determinations for a given factor. Thus, for example, there may also be a “medium” option for determining the size of the region, placed in between. Moving along, the next factor is a determination of the prominence of the region within the image 420 (i.e., background 421 or foreground 422). A determination that the region is in the foreground 421 lends itself to a higher valuation.

Proceeding to the next column, the relevance of the region and/or the image to the web page 430 is determined. Relevant images/regions 431 are weighted higher than irrelevant images/regions 432. Relevance may be determined based on a keyword and/or text comparison. That is, if a website pertains to travel and vacation homes, a photo of a tropical vacation cottage would be very relevant to the web page and thus garner a high score in the “relevance to web page” 430 valuation. If, on the other hand, the web page pertained to sports news, then the photo of a vacation cottage would not be considered relevant.

Proceeding to the next factor, a quality of the image 440 is assessed. Size and/or number of megapixels may be evaluated for this determination. Such evaluation may be carried out via a software algorithm associated with the web page and/or the server. Thus, an image with a high resolution, may be considered high quality (“HQ”) 441. Contrarily, an image that is 150×150 pixel may be considered low quality 442, thereby receiving a low quality valuation. As discussed, there may be more than two valuation levels as shown in FIG. 4. For example, there may be a “medium” valuation level for images of medium resolution.

Another factor in evaluating the region/image is the position of the image on the page 450. For this factor, different positions within a web page may yield different valuations. As such, multiple image positions may be considered. However, for purposes of this example, FIG. 4 shows two positions; top-center 451 and bottom 452. Other possible positions may include in the margins, on the sides, etc. Presumably an image positioned on the top center of a web page would be guaranteed to be viewed by any user who loads the page, in view of the fact that browsers generally show the top-middle upon initial loading. Thus, an image at the top center 451 would receive a high valuation on the scale of FIG. 4.

It is important to note that the scale and steps shown in FIG. 4 are one example of assessing the valuation of an image. The steps need not necessarily be in the particular order shown in FIG. 4. Moreover, different steps may carry different weights, based on which factors are most important for purposes of advertising.

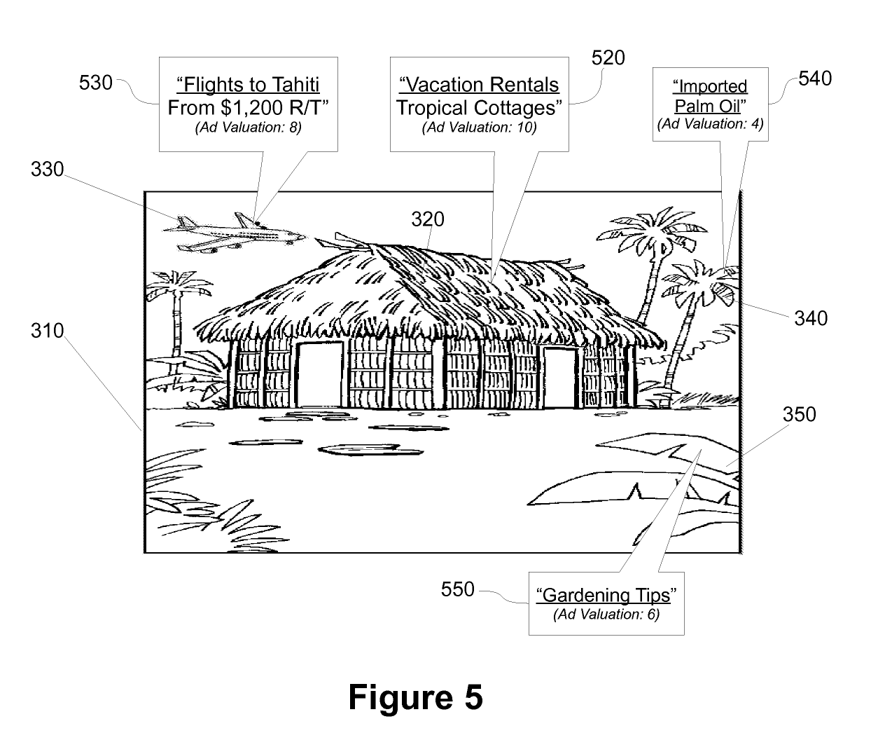

FIG. 5 shows an example of advertisement regions and valuations that may be embedded in the image of FIG. 3. The image 310 is that of a vacation cottage shown on the browser interface of FIG. 3. Central to the image 310 is a cottage 320. As such, the cottage 320 is the focal point of the image, and is likely to be the first object spotted by a user accessing the web page. An ad visualization 520 associated with the cottage 320 contains the text “Vacation Rentals” and “Tropical Cottages.” An ad valuation is shown under the text, assigning a value of 10 to the particular visualization 520 associated with the cottage 320. Such may be visible to advertisers seeking space or regions within the image. The ad valuation would presumably not be displayed to a user who regularly accesses the image 310, however it is shown in FIG. 5 for explanatory purposes. The ad valuation of 10 is assigned to the cottage because the cottage is the focal point of the image, and the image appears on a travel website. As such, under the factors discussed in FIG. 4, an advertisement associated with the cottage would garner a high valuation.

Also present in the accompanying image is a region containing a commercial airplane. As such, a visualization associated with the airplane 330 advertises “Flights to Tahiti.” The ad valuation shown for the airplane is 8, because although the airplane is relevant to the website, it is in the background of the image 310. (i.e., it is not the focal point). Another region of the image 310 shows palm trees 540 next to and behind the cottage 320. The palm trees 540 also have an advertisement associated therewith. The advertisement 540 associated with palm trees pertains to “Imported Palm Oil.” Because palm oil is not relevant to travel and vacation, and because the palm trees 540 are in the background of the image 310, the palm trees have a lower ad valuation of 4. Additionally, plants 350 in the front of the image 310 advertise “Gardening Tips” with an ad valuation of 6. The plants 350 have a higher ad valuation than the palm trees 340 because the plants are positioned in the front of the image 310.

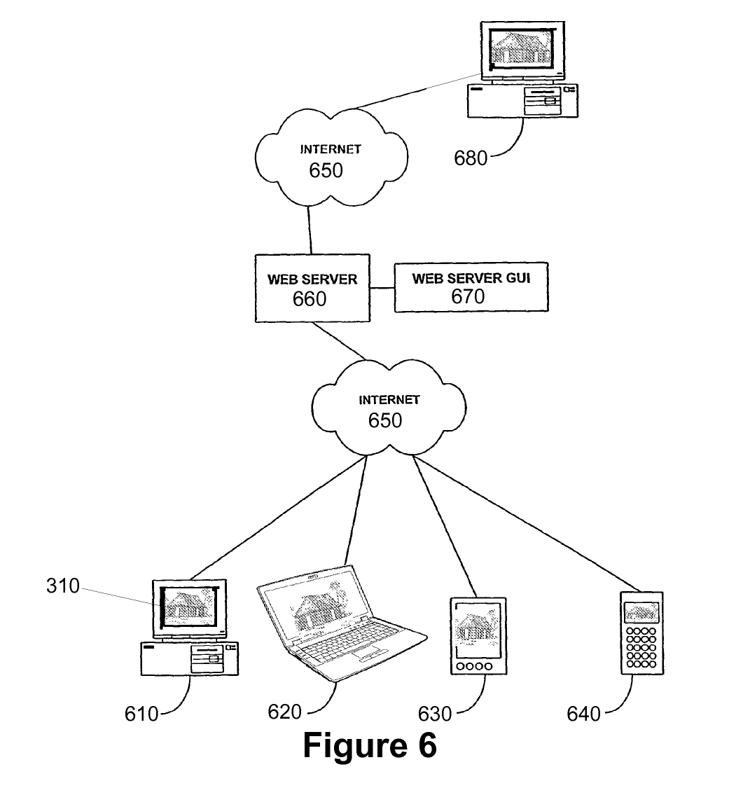

FIG. 6 shows a high-level diagrammatic overview of a network configuration for carrying out an embodiment of the disclosed technology. The network generally may have a number of network-connected devices 610, 620, 630, 640 connected to the Internet 650 via a data network, such as, for example, a packet-switch data network, a Local Area Network, a Wide Area Network, etc. The Internet 650 is defined as a series of interconnected packet-switch networks through which digital data may be sent, received, and stored. The devices 610-640 communicate with a web server 660 via the Internet 650. The web server 660 is associated with a web server graphical user interface 670. The web server 660 is managed by a host computer 680 via the Internet 650. Thus, changes may be made to the graphical user interface 670, using the host computer 680 having a non-transitory computer readable storage medium. The storage on the host computer 680 may have instructions designed to be carried out by a processor.

The devices 610-640 may access an image on a web page, such as those described in FIGS. 1-5 on a network configuration similar to that of FIG. 6. For example, a personal computer 610 may load the image and/or web page via a browser interface. As such, the image 310 and associated advertisements are displayed to a user via the screen of the personal computer. Similarly, a laptop computer 620, a tablet 630 and/or a mobile phone 640 may access and display the image 310 and/or web page. These devices may be connected to the Internet in any number of ways. For example, the mobile phone 640 may be connected to the Internet via a packet-switch data network, whereas the tablet 630 may have wi-fi connectivity. The personal computer 610 may be connected, for example, to a Local Area Network (“LAN”) via a wired Ethernet connection.

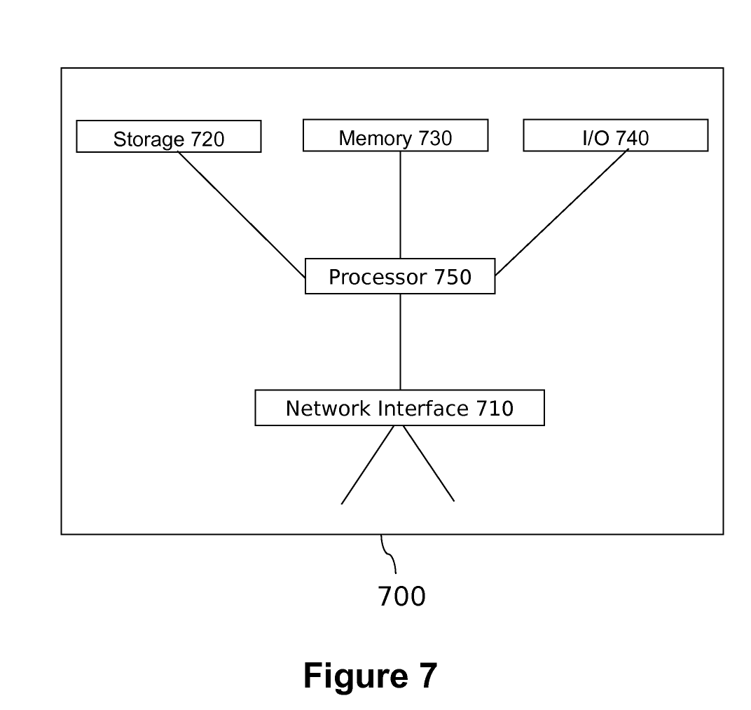

FIG. 7 shows a high-level block diagram of a device that may be used to carry out the disclosed technology. Device 700 comprises a processor 750 that controls the overall operation of the computer by executing the device's program instructions which define such operation. The device's program instructions may be stored in a storage device 720 (e.g., magnetic disk, database) and loaded into memory 730 when execution of the console's program instructions is desired. Thus, the device's operation will be defined by the device's program instructions stored in memory 730 and/or storage 720, and the console will be controlled by processor 750 executing the console's program instructions. A device 700 also includes one or a plurality of input network interfaces for communicating with other devices via a network (e.g., the Internet). The device 700 further includes an electrical input interface for receiving power and data from a power source. A device 700 also includes one or more output network interfaces 710 for communicating with other devices. Device 700 also includes input/output 740, representing devices which allow for user interaction with a computer (e.g., mouse, display, keyboard, etc.). One skilled in the art will recognize that an implementation of an actual device will contain other components as well, and that FIG. 7 is a high level representation of some of the components of such a device for illustrative purposes. It should also be understood by one skilled in the art that the method and devices depicted in FIGS. 1 through 6 may be implemented on a device such as is shown in FIG. 7.

A “non-transitory computer readable storage medium” is, for purposes of this specification, any form of computer-readable media that has the ability to electrically, magnetically, and/or mechanically dent or otherwise change the physical shape or chemical properties of a physical device in order to store data for a period of time of at least 1 hour or a length of time which may be later decided by a court of law to be considered “non-transitory”. Such may include register memory, processor cache, and Random Access Memory (RAM). Such a “computer readable storage medium” may include forms of non-tangible media and transitory propagation of signals.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

1. A method of using artificial intelligence to set a value on a clickable portion of an image comprising:
displaying a rendered visual representation of a webpage on a display device, said webpage comprising an image;
defining at least one region within said image, said at least one region comprising a detected visual representation of an object;
valuating, using a processor, said at least one region based on properties of said region relative to said image;
valuating, using a processor, the entirety of said image based on characteristics of said image and placement of said image within said webpage; and
charging an advertiser a price for an advertisement associated with said region based on said steps of valuating.

2. The method of claim 1 wherein said step of valuating each said region is based on at least two of:
a position of said region in said image;
a size of said region relative to said image; and
a relevance of said region to said page.

3. The method of claim 2, wherein said relevance of said region to said page is based on text displayed on said page.

4. The method of claim 3, wherein said relevance of said region to said page is further based on content displayed on said page.

5. The method of claim 1 wherein said step of valuating said image itself is based on:
a position of said image on said page;
a relevance of said image to said page; and
a quality of said image.

6. The method of claim 1, further comprising a step of:
setting a keyword associated with said region, said keyword representative of content of said region.

7. The method of claim 1, where said assigned price is a starting bid price of an advertising content auction.

8. A method of setting an auction price of an advertisement associated with a region of an image comprising:
setting a keyword associated with said region, said keyword representative and descriptive of content of said region;
determining a characteristic of said region relative to other parts of said image;
determining a quality of said image;
determining a position and prominence of said image on a page;
determining a position and prominence of said region within said image; and
setting a starting bid price based on said steps of determining.

9. The method of claim 8, wherein said steps of determining are carried out by way of sending instructions to a physical processor.

10. The method of claim 8, wherein a rating is assigned to said region based on said steps of determining.

11. The method of claim 8, wherein said step of determining position and prominence of said region within said image is based on whether said region is determined to be in a background or a foreground of the image.

12. The method of claim 8, wherein said image is displayed on a rendered visual representation of a webpage on a display device.

13. A non-transitory computer-readable storage medium, comprising artificial intelligence instructions designed to be carried out by a processor, said instructions comprising:
displaying a rendered visual representation of an image;
defining at least one region within said image, said at least one region comprising a detected visual representation of an object;
valuating said at least one region based on properties of said region relative to said image;
valuating the entirety of said image based on a position of said image; and
charging an advertiser a price for an advertisement associated with said region based on said steps of valuating.

14. The non-transitory computer-readable storage medium of claim 13, wherein said visual representation of an image is displayed on a web page accessible by a display device.

15. The non-transitory computer-readable storage medium of claim 14, wherein said instructions further comprise:
valuating a placement of said image within said web page.

16. The non-transitory computer-readable storage medium of claim 14, wherein said instructions further comprise:
valuating a relevance of said region to said web page.

17. The non-transitory computer-readable storage medium of claim 16, wherein said relevance of said region to said page is based on text displayed on said web page.

18. The non-transitory computer-readable storage medium of claim 16, wherein said instructions further comprise:
setting a keyword associated with said region, said keyword representative of content of said region.

19. A non-transitory computer-readable storage medium, comprising artificial intelligence instructions designed to be carried out by a processor device, said instructions comprising:
displaying a rendered visual representation of an image transmitted over a network node;
defining at least one region within said image;
auctioning, to a plurality of potential advertisers, which destination webpage will be shown to a user who clicks on said at least one region; and
charging a winning said advertiser a price for an advertisement associated with said region.

20. The non-transitory computer-readable storage medium of claim 19, wherein upon receiving a click of on said at least one region via said network node, a uniform resource locater of a destination webpage associated with said winning advertiser is sent via said network node to said user who clicked on said at least one region.
